(19) United States
(12) Patent Application Publication
(10) Pub. No.: US 2025/0093756 A1
(43) Pub. Date: Mar. 20, 2025

(54) Folding Teleprompter Device for Enhanced Eye Contact During Video Interviews and Presentations

(71) Applicant: Steve Lord, Ilkley (GB)

(72) Inventor: Steve Lord, Ilkley (GB)

(21) Appl. No.: 18/885,716

(22) Filed: Sep. 15, 2024

Related U.S. Application Data
(60) Provisional application No. 63/538,728, filed on Sep. 15, 2023.

(51) Int. Cl. G03B 17/56; G06F 1/16; H04N 5/222

(52) U.S. Cl. CPC G03B 17/565; G06F 1/1681; H04N 5/2222

(57) ABSTRACT

The invention is a folding prompter device designed to facilitate direct eye contact between a subject and a camera lens during interviews and presentations. Constructed from lightweight carbon fiber panels, the device is compact, portable, and easy to assemble, making it ideal for mobile journalism, education, and video production. Key features include an adjustable tablet holder with clamps, an adjustable side mirror panel, a pan and tilting friction hinge for beamsplitter glass adjustment, and a quick-release bracket system for secure camera mounting. The device's folding mechanism allows for quick setup and breakdown, enabling seamless transitions between scripted and unscripted content formats. By integrating these components into a single, user-friendly unit, the invention provides a versatile and practical solution for professionals needing a high-quality, portable teleprompter system that maintains audience engagement through eye contact with the camera.

### CROSS-REFERENCE TO RELATED APPLICATIONS

The present utility application claims the priority of the U.S. provisional patent application No. 63/538,728 filed on Sep. 15, 2023.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates to the field of broadcast and video production technology, specifically to camera accessories designed to facilitate real-time interviews, presentations, and other on-camera interactions. More particularly, it concerns a folding teleprompter device that enables direct eye contact between the subject and the camera lens, enhancing viewer engagement for broadcast journalists, content creators, educators, and other professionals requiring seamless communication with the camera while referring to scripted or prompted content.

### BACKGROUND OF INVENTION

In the fields of broadcast journalism, education, and video production, maintaining eye contact with the camera lens is a critical component for establishing a connection and rapport with the audience. Eye contact is particularly important for live broadcasts, interviews, educational videos, and other forms of visual communication where audience engagement is key. Traditionally, teleprompters are used to facilitate this connection by displaying scripted text directly in front of the camera lens, enabling the presenter to read the script while appearing to look directly at the viewer. This is achieved by using beamsplitter glass, which reflects the text from a monitor or tablet placed below or above the camera lens, while the camera captures the image through the glass without showing the text.

However, conventional teleprompter systems have several limitations that restrict their usability, especially in dynamic and mobile environments. Traditional teleprompters are often bulky and cumbersome, requiring a significant amount of time and effort to set up and dismantle. This makes them impractical for use in situations that demand quick setups, such as on-the-fly field interviews, guerrilla journalism, or mobile recording sessions. These systems are usually mounted on heavy tripods and are often tethered to a power source, necessitating extensive cabling and limiting their portability. As a result, they are predominantly used in controlled studio environments where space, power, and setup time are not limiting factors.

Moreover, the transportation of conventional teleprompters is often cumbersome due to their size, weight, and fragility. The glass beamsplitter component is particularly delicate and prone to damage if not handled with care, further complicating its transport. The bulk and fragility necessitate additional packaging materials and transport containers, which in turn increase the logistical burden on production teams, especially those operating in remote locations or areas with limited access. This can often require a dedicated crew solely for the setup, operation, and breakdown of the teleprompter system.

Additionally, conventional teleprompter systems usually require specific mounting hardware, such as rods, rails, or cages, to securely attach the system to the camera setup. These components are often proprietary and may not be compatible with all camera rigs, further limiting their versatility. Moreover, the alignment of the camera, teleprompter, and beamsplitter glass requires careful calibration to ensure proper functionality and the desired effect of seamless eye contact. This process can be time-consuming and may require specialized tools or expertise, thereby reducing the overall efficiency of the production workflow.

Another significant drawback of conventional teleprompters is their lack of flexibility to accommodate both scripted and unscripted content. While they work well in delivering scripted narratives, they are not conducive to dynamic interviews or unscripted discussions where the subject may need to shift between looking at the interviewer and reading prompts. Traditional teleprompters do not offer an easy way to accommodate these needs without additional equipment or complex setups, limiting their adaptability to different interview styles and formats.

Furthermore, the reliance on external power sources and the need for specific software to operate the teleprompter system can introduce additional points of failure. Power outages, software crashes, or compatibility issues can lead to interruptions during live broadcasts or critical recording sessions, potentially compromising the quality of the production and viewer experience. The dependence on multiple interconnected systems also creates a more complex technical ecosystem that requires constant monitoring and troubleshooting, thereby increasing the chances of errors and technical difficulties.

Therefore, there exists a strong need in the broadcast and video production industry for a teleprompter system that is portable, lightweight, easy to set up, and versatile enough to be used in a variety of settings, both controlled and uncontrolled. Such a system should enable quick transitions between different modes of operation, including scripted and unscripted formats, without the need for extensive equipment, calibration, or setup time. It should also allow for secure and flexible mounting to a variety of camera rigs, accommodate different sizes of prompting devices such as tablets, and minimize the risk of damage during transport.

The present invention addresses these needs by providing a folding prompter device that is engineered for quick deployment and compact storage. The device is constructed from lightweight carbon fiber panels for durability and ease of transport, and it features a quick-release mounting system compatible with standard camera rails. Its design includes an adjustable tablet holder, an adjustable side mirror panel, and a beamsplitter glass mounted on a pan and tilting friction hinge, all of which contribute to its versatility and ease of use. This folding prompter device can be quickly set up and disassembled without the need for specialized tools, making it ideal for mobile journalists, educators, content creators, and other professionals who require a high-quality, portable teleprompter solution that facilitates eye contact with the camera lens.

### BRIEF SUMMARY OF THE INVENTION

The present invention is a folding prompter device specifically designed to address the limitations of traditional teleprompter systems used in broadcast journalism, education, video production, and other fields where on-camera presence and engagement are crucial. The folding prompter device enables direct eye contact between the subject and the camera lens while allowing for seamless delivery of both scripted and unscripted content. Constructed from lightweight and durable carbon fiber panels, the device is highly portable, compact, and easy to assemble, making it ideal for use in a variety of settings, including field interviews, mobile recording sessions, and other dynamic environments.

The folding prompter device features several innovative components and functionalities to enhance its usability and versatility:
1. Main Folding Box: The core structure of the device is a box-like enclosure made of lightweight carbon fiber panels, which can be folded flat for ease of transport. This compact design significantly reduces the storage footprint and allows for quick deployment and breakdown.
2. Adjustable Tablet Holder with Clamps: The device is equipped with an adjustable tablet holder that can accommodate various sizes of tablet devices. The holder securely clamps the tablet in place, displaying scripted content that can be reflected onto a beamsplitter glass for the subject to read while maintaining eye contact with the camera lens.
3. Adjustable Side Mirror Panel: An innovative side mirror panel, mounted on a thumbscrew, can be tilted to various angles, allowing the subject to either view the interviewer or read the scripted content. This dual functionality provides flexibility in both scripted and unscripted interview formats, making the device adaptable to different production needs.
4. Pan and Tilting Friction Hinge: The folding prompter device incorporates a pan and tilting friction hinge that provides smooth, controlled movement for precise adjustment of the beamsplitter glass angle. This ensures that the subject can maintain optimal eye contact with the camera lens, regardless of their height, seating position, or orientation.
5. Bracket with Rail Block and Quick-Release System: The device includes a specially designed bracket with a rail block that attaches to standard 15 mm camera rails. The quick-release mechanism allows for fast, secure mounting and dismounting, making the setup and breakdown processes efficient and straightforward.
6. Beamsplitter Glass: The device uses high-quality beamsplitter glass that reflects the text displayed on the tablet to the subject while remaining invisible to the camera. The glass is removable for ease of transport and can be adjusted to the desired angle using the friction hinge mechanism.

By integrating these features into a single, compact, and easy-to-assemble unit, the folding prompter device provides a practical and flexible solution for facilitating eye contact during interviews, presentations, or any other on-camera appearances. It is designed to be versatile, portable, and user-friendly, enabling both novice and experienced users to achieve professional-quality video production in various environments without the need for specialized tools or extensive setup time.

The invention thus meets the needs of mobile journalists, content creators, educators, and other professionals who require a reliable and adaptable teleprompter system for engaging with their audience, whether in a studio setting or in the field.

### DESCRIPTION OF THE DRAWINGS

The accompanying drawings serve to provide a further understanding of the invention. They are incorporated in and constitute a part of this specification, illustrating the embodiments of the invention and together with the description, serve to explain the principles of the invention.

FIG. 1 is a top front perspective view of the folding prompter device in its unfolded position.

FIG. 2 is a top rear perspective view of the folding prompter device in its unfolded position.

FIG. 3 is a front view of the folding prompter device in its unfolded position.

FIG. 4 is a left view of the folding prompter device in its unfolded position.

FIG. 5 is a right view of the folding prompter device in its unfolded position.

FIG. 6 is a top view of the folding prompter device in its unfolded position.

FIG. 7 is a bottom view of the folding prompter device in its unfolded position.

FIG. 8 is a top front perspective view of the folding prompter device in its mid-folded position.

FIG. 9 is a top rear perspective view of the folding prompter device in its mid-folded position.

FIG. 10 is a rear view of the folding prompter device in its mid-folded position.

FIG. 11 is a side view of the folding prompter device in its mid-folded position.

FIG. 12 is a top view of the folding prompter device in its mid-folded position.

FIG. 13 is a top front perspective view of the folding prompter device in its fully folded position.

FIG. 14 is a top rear perspective view of the folding prompter device in its fully folded position.

FIG. 15 is a front view of the folding prompter device in its fully folded position.

FIG. 16 is a side view of the folding prompter device in its fully folded position.

FIG. 17 is a top view of the folding prompter device in its fully folded position.

FIG. 18 is a bottom view of the folding prompter device in its fully folded position.

FIG. 19 is to show the folding process of the folding prompter device from front and rear views.

FIG. 20 is to show the parts of the folding prompter device from the front view.

FIG. 21 is to show how the invention works.

FIG. 22 is to show how the invention works.

### REFERENCE NUMERALS IN THE DRAWINGS

100. The folding prompter device
102. Tablet holder with adjustable clamps
104. Adjustable side mirror panel
106. Pan and tilting friction hinge
108. Main folding box
110. Bracket with railblock
112. Quick release system for bracket
114. Beamsplitter
200. Subject
202. interviewer
204. camera operator

### DETAILED DESCRIPTION OF THE INVENTION

The present invention relates to a folding prompter device (100) designed to enable direct eye contact between the subject and the camera lens during interviews and presentations. This device is particularly advantageous for mobile journalists, content creators, educators, and other professionals who require a portable, easy-to-set-up teleprompter system that can facilitate both scripted and unscripted interactions. The invention incorporates several innovative features that distinguish it from traditional teleprompter systems, providing significant improvements in portability, ease of use, and adaptability.

### Overview of the Folding Prompter Device

The folding prompter device (100) is primarily composed of a main folding box (108) constructed from lightweight and durable carbon fiber panels, allowing for easy transport and quick assembly. The device includes several key components designed to provide functionality, versatility, and ease of use: an adjustable tablet holder (102) with clamps for securing a tablet, an adjustable side mirror panel (104), a pan and tilting friction hinge (106) for precise angle adjustments, a quick-release system (112) for fast mounting and disassembly, and a high-quality beamsplitter glass (114). The detailed descriptions of these components, along with their functions and interrelationships, are provided below.

### Main Folding Box (108)

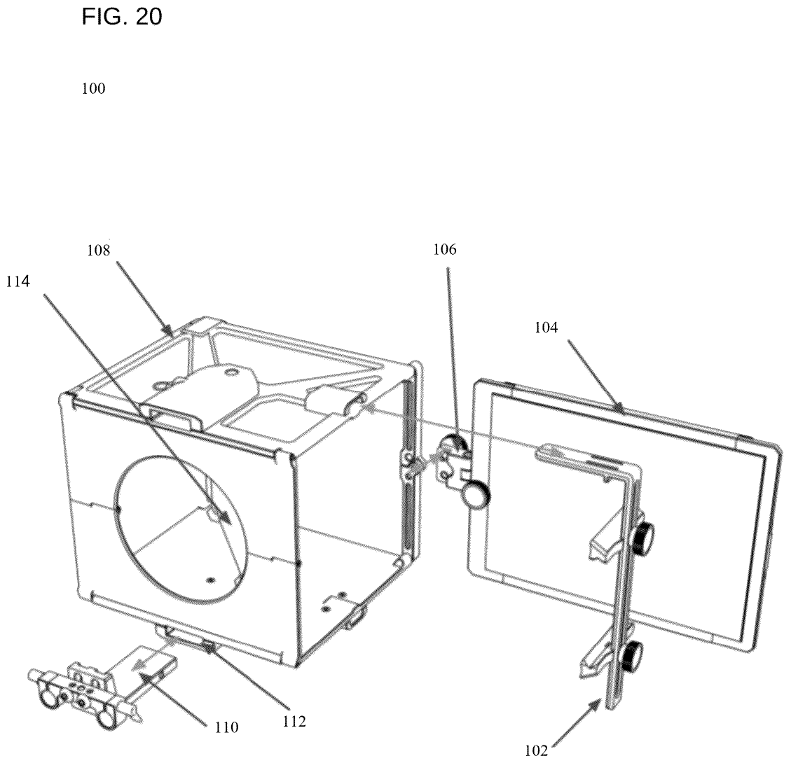

As shown in FIG. 20, the main folding box (108) serves as the primary structure for the folding prompter device (100). The box is made from lightweight carbon fiber panels, providing a strong yet portable housing for the device's components. The folding mechanism of the main box allows it to collapse into a flat configuration, minimizing its volume for easy transport. This folding capability is particularly useful for on-the-go professionals who require a compact teleprompter solution that can be quickly deployed or stored without the need for additional packing materials or protective cases.

The main folding box (108) is designed to accommodate various accessories and components securely while maintaining a balanced weight distribution to ensure stability when mounted on a camera rig. The folding mechanism itself is a key innovation, allowing the entire device to be set up or disassembled in a matter of seconds without the need for specialized tools.

### Tablet Holder with Adjustable Clamps (102)

The tablet holder (102), as depicted in FIG. 20, is a crucial component of the folding prompter device (100). It is equipped with adjustable clamps designed to securely hold a variety of tablet sizes, providing flexibility for the user to choose a preferred device for displaying scripted content. The clamps are designed with a rubberized grip to prevent slippage and potential damage to the tablet while allowing for easy insertion and removal.

When the tablet is clamped in place, the content displayed on the tablet screen is reflected onto the beamsplitter glass (114) positioned in front of the camera lens. This setup allows the subject to read the content while maintaining eye contact with the camera, thereby creating a more natural and engaging viewer experience. The adjustable feature of the clamps ensures that the tablet holder (102) can be positioned at the optimal angle and height relative to the beamsplitter glass (114) to accommodate various presenter preferences and needs.

### Adjustable Side Mirror Panel (104)

The adjustable side mirror panel (104) is another innovative feature of the folding prompter device (100). As illustrated in FIG. 20, the side mirror panel is mounted on a thumbscrew, allowing it to be tilted to different angles. This feature provides dual functionality: the subject can either see the interviewer through the mirror or read the scripted content reflected on the beamsplitter glass (114). This flexibility makes the device particularly useful for unscripted interviews, where the subject may need to shift focus between the interviewer and the scripted content.

The adjustable side mirror (104) can be quickly repositioned to suit different interview formats and styles, enhancing the adaptability of the device. This feature is especially beneficial in dynamic shooting environments, where rapid changes in setup may be required.

### Pan and Tilting Friction Hinge (106)

The pan and tilting friction hinge (106), shown in FIG. 20, is designed to provide smooth and controlled movement for adjusting the beamsplitter glass (114) angle. This hinge allows for precise positioning of the glass, ensuring that the subject can maintain optimal eye contact with the camera lens regardless of their height, seating position, or orientation. The friction hinge mechanism provides just the right amount of resistance to keep the glass stable in the desired position while still allowing for easy adjustments without additional tools.

This component is crucial for customizing the setup to match different camera heights and presenter positions, making it versatile for various production settings. The hinge's design ensures that the beamsplitter glass (114) remains securely in place even during dynamic movement or repositioning of the camera rig.

### Bracket With Rail Block (110) and Quick-Release System (112)

The folding prompter device (100) incorporates a specially designed bracket (110) with a rail block that attaches to standard 15 mm camera rails. The quick-release system (112), as shown in FIG. 20, allows for fast and secure mounting and dismounting of the device on the camera rig. This feature significantly reduces the setup and breakdown times, which is particularly beneficial for field reporters and mobile journalists who operate in time-sensitive environments.

The quick-release system (112) is engineered to provide a robust and secure connection while allowing for effortless detachment when needed. This system is compatible with various camera rigs and accessories, enhancing the device's flexibility and applicability across different production setups.

### Beamsplitter Glass (114)

The beamsplitter glass (114), depicted in FIG. 20, is a critical component of the folding prompter device (100). It reflects the text displayed on the tablet (102) to the subject while remaining invisible to the camera. The glass is mounted on the pan and tilting friction hinge (106), allowing for precise angle adjustments to suit different viewing and camera configurations.
The beamsplitter glass (114) is removable for ease of transport, reducing the risk of damage during movement. The glass is made from high-quality optical material to ensure clear reflection without distortion, which is essential for maintaining professional video production standards.

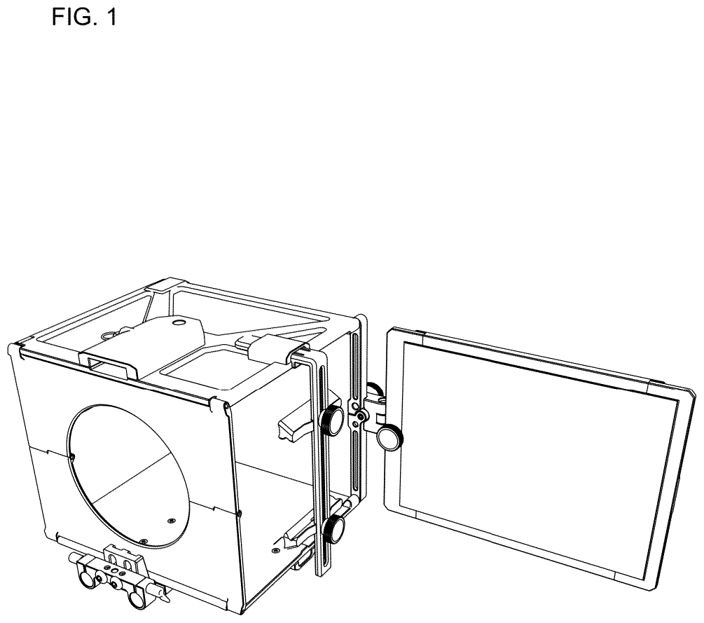

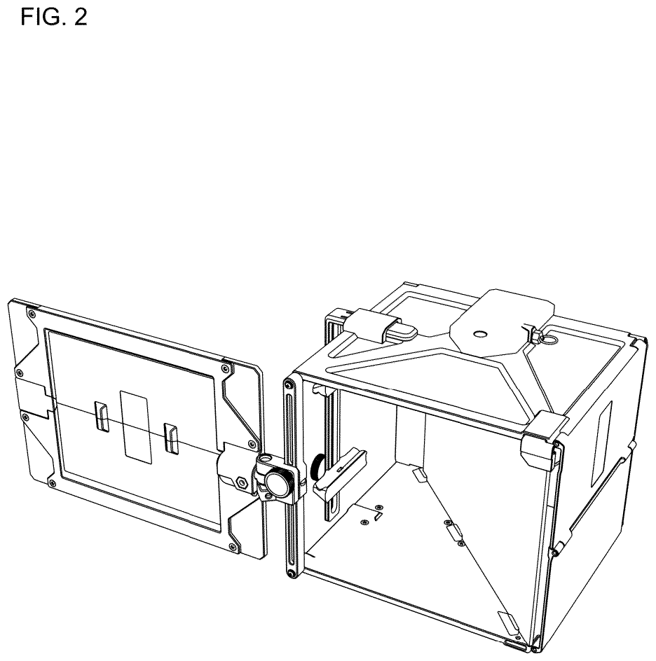

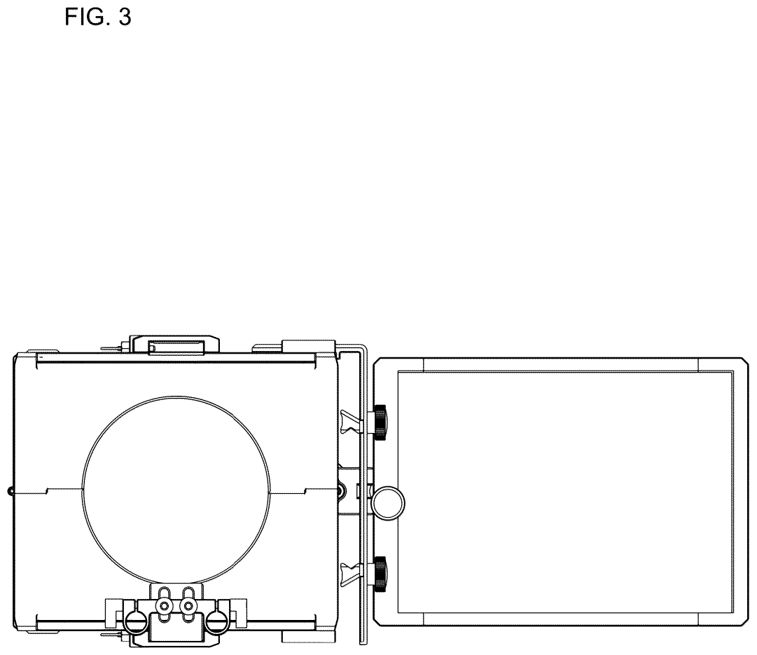

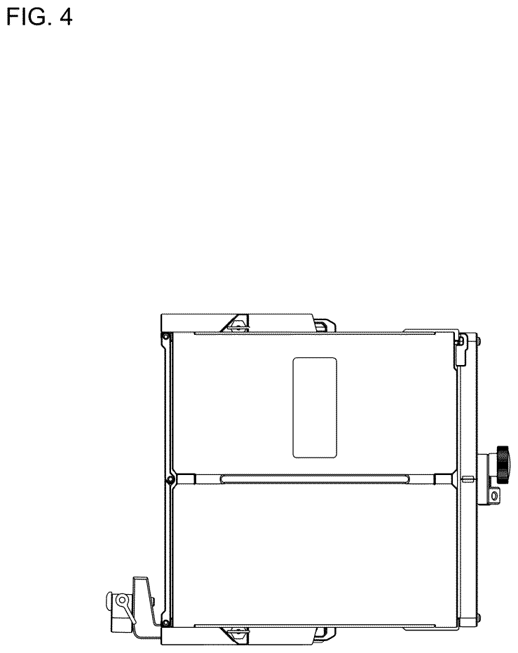

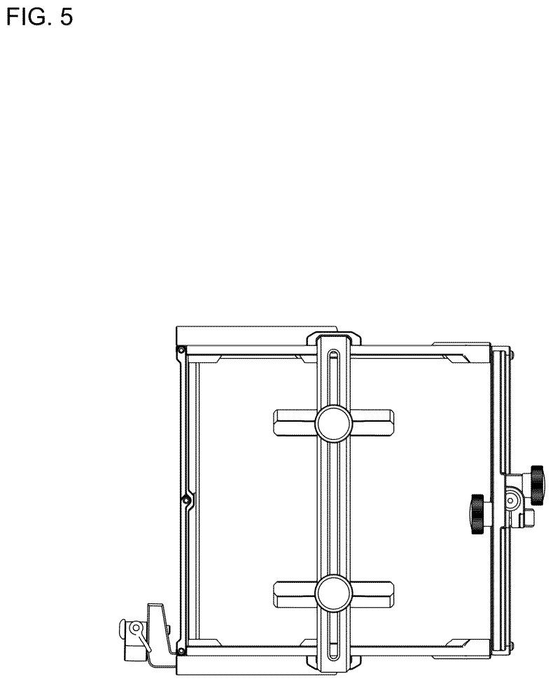

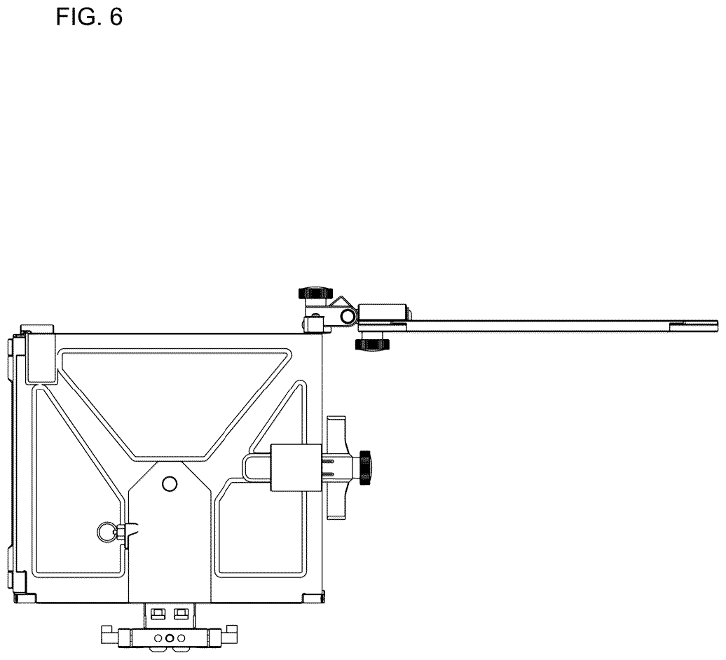

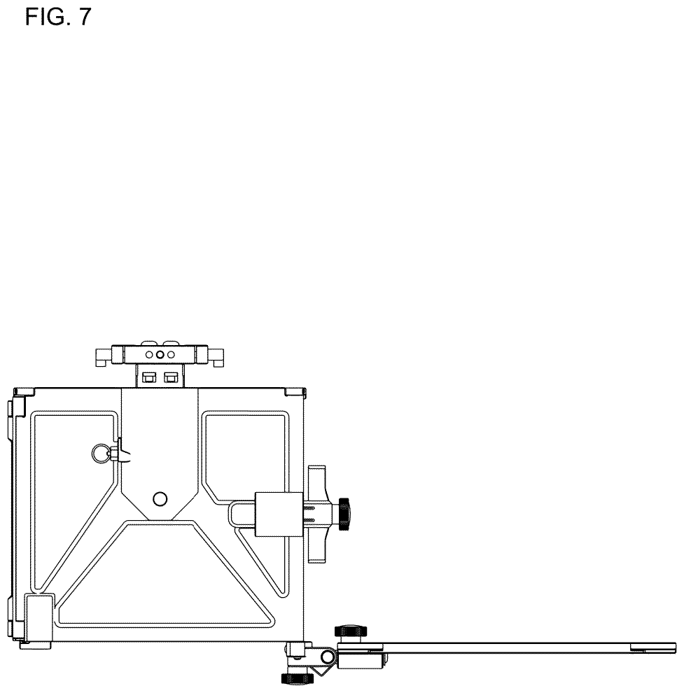

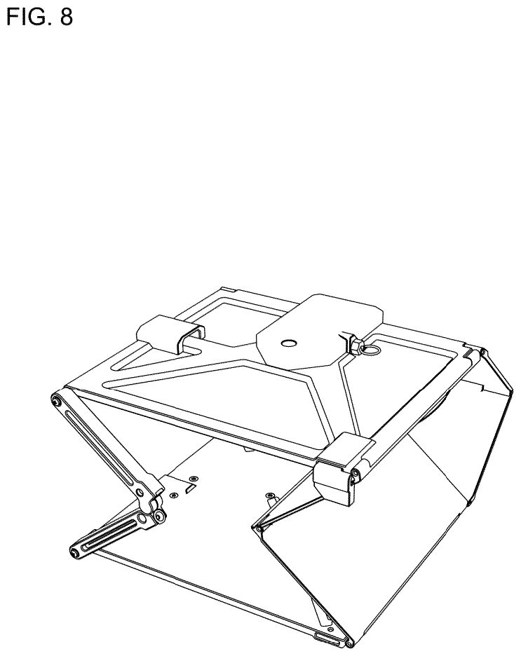

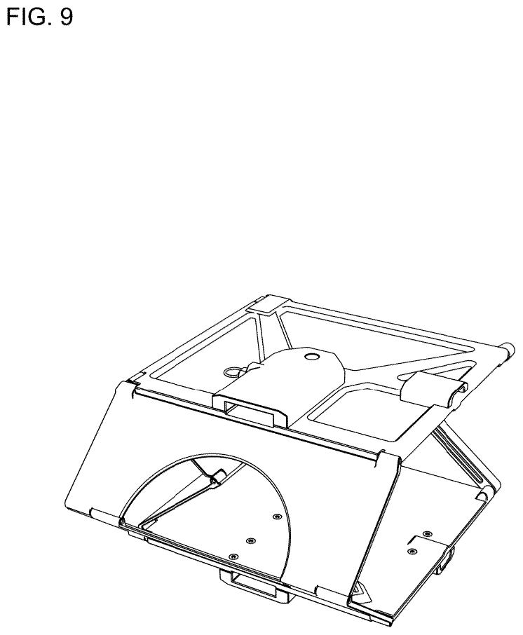

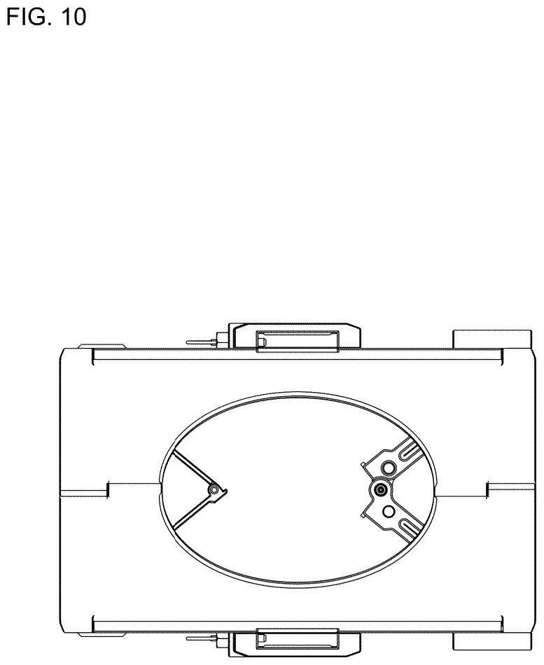

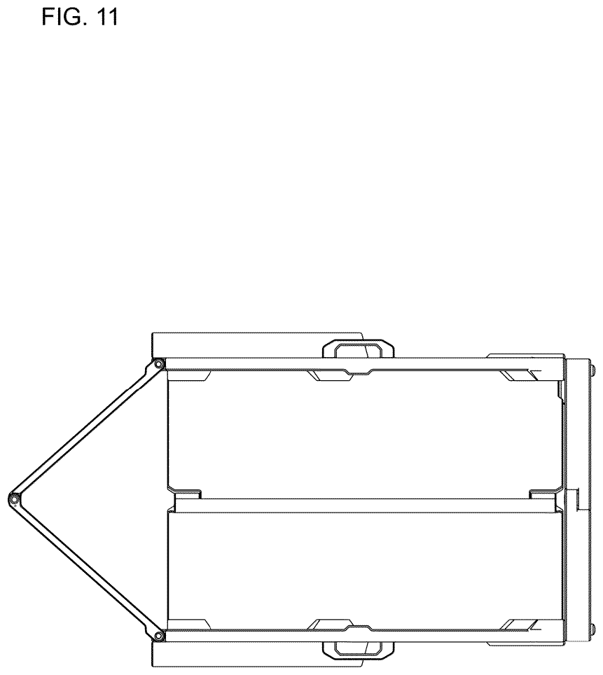

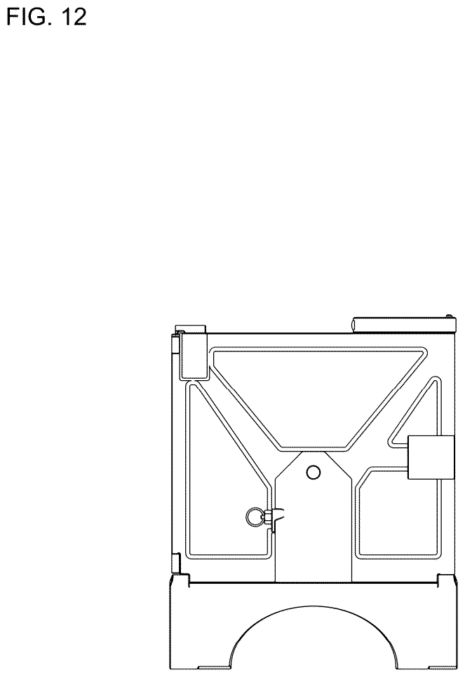

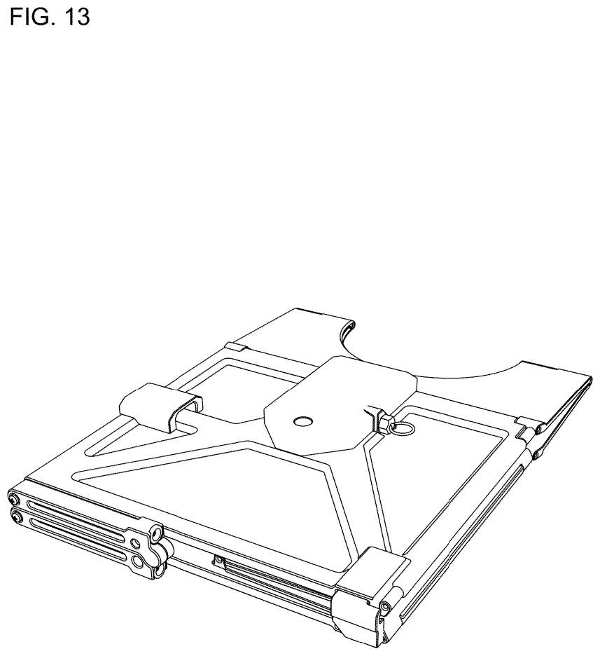

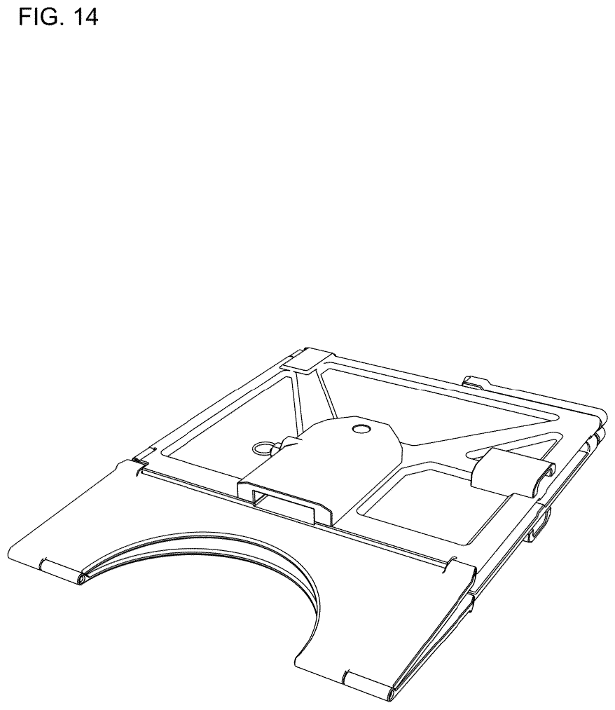

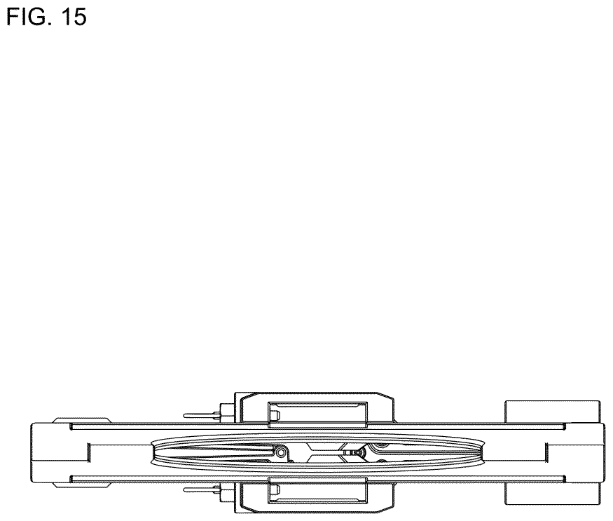

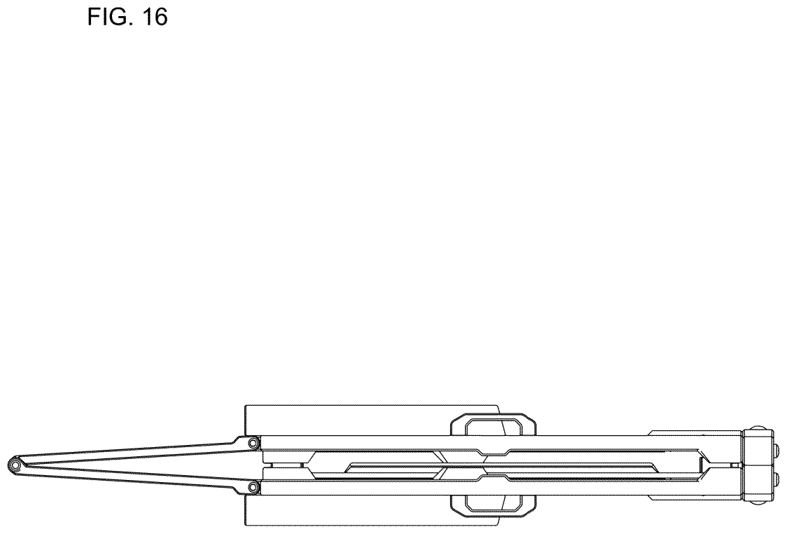

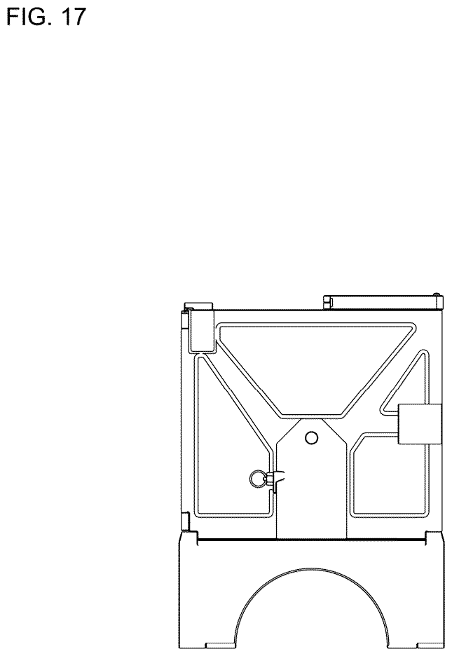

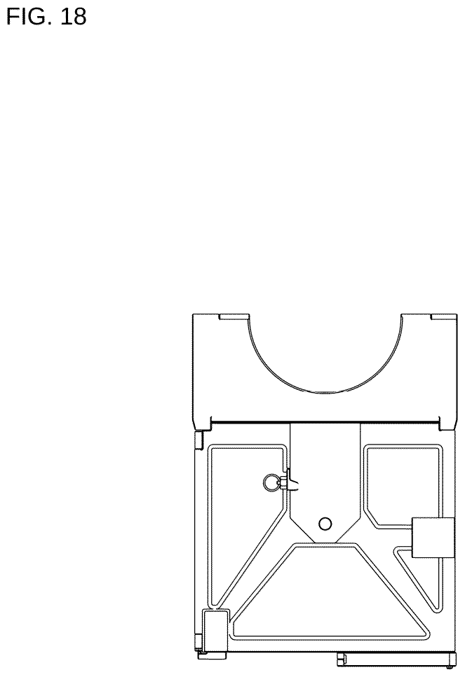

### Folding Mechanism and Positions (Illustrated in FIGS. 1 to 19)

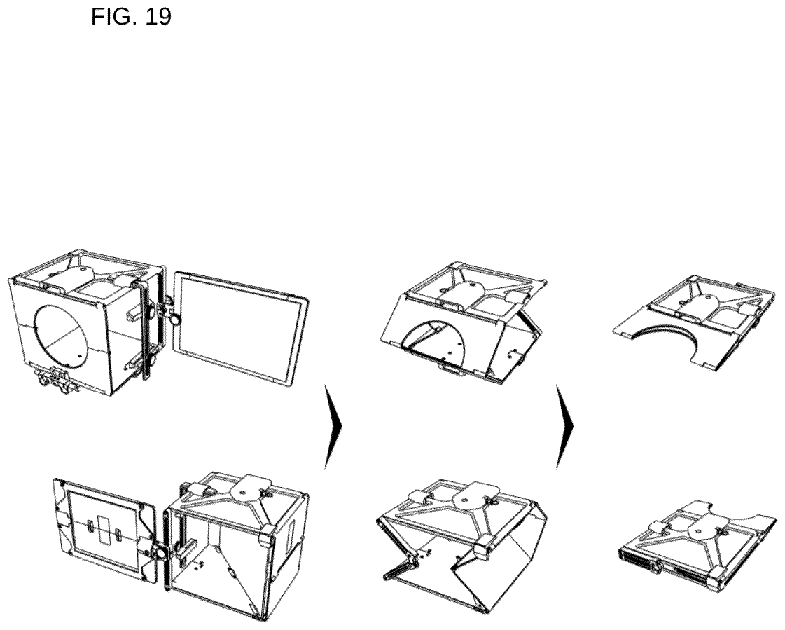

FIGS. 1 to 18 illustrate various views of the folding prompter device (100) in its unfolded, mid-folded, and fully folded positions. These figures provide a comprehensive overview of the device's compactness and the ease with which it can transition between different configurations. FIG. 19 specifically shows the folding process from various perspectives, detailing the sequence of steps required to move the device from its unfolded to fully folded state.

The folding mechanism of the main box (108) and associated components is designed to allow for rapid transitions between operational and storage configurations. This design minimizes the time and effort required for assembly and disassembly, providing a significant advantage over traditional, bulkier teleprompter systems.

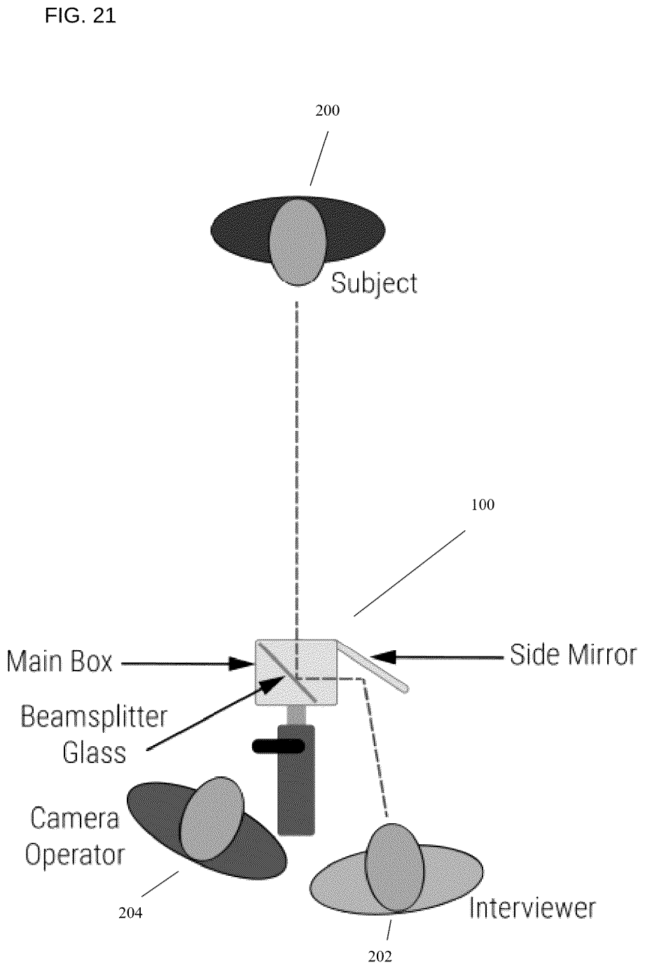

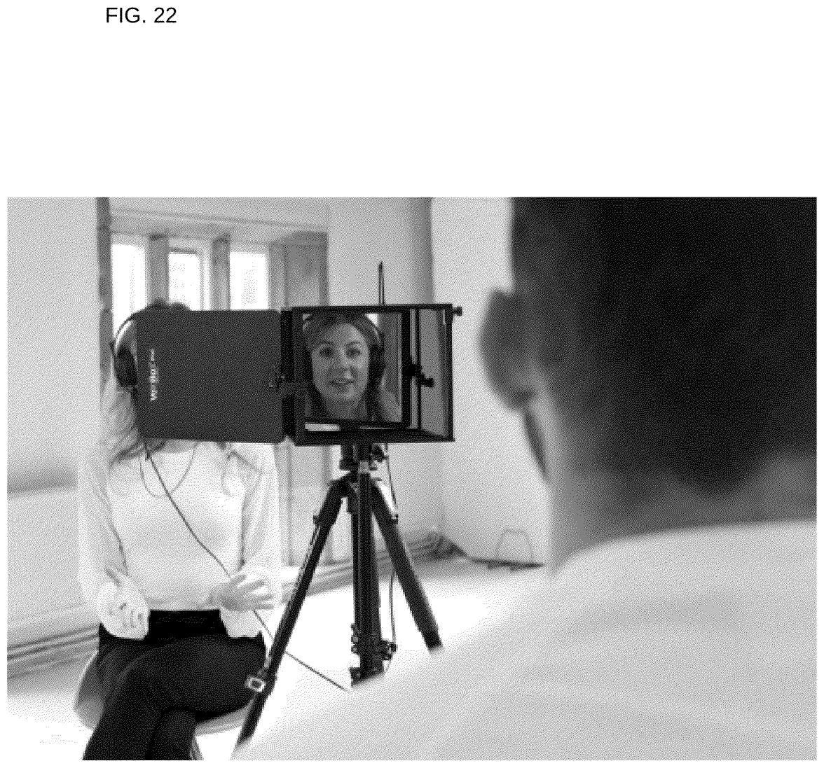

### Operational Method (Illustrated in FIGS. 21 and 22)

FIGS. 21 and 22 illustrate how the folding prompter device (100) operates in a real-world scenario involving a subject (200), an interviewer (202), and a camera operator (204). In these figures, the side mirror (104) and beamsplitter glass (114) are strategically positioned to allow the subject (200) to maintain eye contact with the camera lens through the beamsplitter glass (114) while either viewing the interviewer (202) or reading the scripted content.

The operational method involves setting up the device on a camera rig using the quick-release system (112), adjusting the tablet holder (102) and side mirror (104) for optimal viewing, and positioning the beamsplitter glass (114) using the pan and tilting friction hinge (106). The device's versatile design enables it to accommodate both scripted presentations and spontaneous interviews without requiring extensive recalibration or adjustment.

What is claimed is:

1. A folding prompter device comprising:
a main folding box made of lightweight carbon fiber panels, configured to fold flat for ease of transport and storage;
an adjustable tablet holder with clamps, capable of securely holding a tablet device to display scripted content;
an adjustable side mirror panel mounted on a thumbscrew, allowing for tiltable adjustment to enable the subject to view either an interviewer or the scripted content;
a pan and tilting friction hinge for precise adjustment of the angle of a beamsplitter glass;
a beamsplitter glass configured to reflect the scripted content displayed on the tablet while maintaining visibility through the camera lens;
a bracket with a rail block and a quick-release system designed for fast and secure mounting to standard camera rails.

2. The folding prompter device of claim 1, wherein the main folding box includes interlocking panels that allow for rapid folding and unfolding without the need for specialized tools.

3. The folding prompter device of claim 1, wherein the adjustable tablet holder is configured to accommodate various tablet sizes and is fitted with rubberized grips to prevent slippage and damage to the tablet device.

4. The folding prompter device of claim 1, wherein the adjustable side mirror panel provides dual functionality by enabling the subject to switch between viewing the interviewer and reading the scripted content without repositioning the device.

5. The folding prompter device of claim 1, wherein the pan and tilting friction hinge provides smooth, controlled movement with a resistance level that maintains the beamsplitter glass at the desired angle.

6. The folding prompter device of claim 1, wherein the beamsplitter glass is made from high-quality optical material to ensure clear reflection without distortion and is removable for ease of transport.

7. The folding prompter device of claim 1, wherein the quick-release system is configured to provide a robust and secure connection to the camera rails while allowing for effortless detachment.

8. The folding prompter device of claim 1, wherein the device is designed for quick assembly and disassembly without requiring specialized tools, enabling rapid deployment in dynamic environments.

9. The folding prompter device of claim 1, further comprising a mechanism that allows the folding prompter device to transition between fully folded, mid-folded, and fully unfolded positions.

10. A method of using a folding prompter device for facilitating eye contact during interviews or presentations, the method comprising the steps of:
mounting the folding prompter device onto a camera rig using the quick-release system and bracket with rail block;
adjusting the tablet holder to securely hold a tablet displaying scripted content;
positioning the adjustable side mirror panel to allow the subject to either view the interviewer or read the scripted content;
using the pan and tilting friction hinge to adjust the beamsplitter glass angle for optimal visibility;
conducting an interview or presentation with the subject maintaining eye contact through the beamsplitter glass while reading the scripted content displayed on the tablet.

11. The method of claim 10, wherein the folding prompter device is adjusted to accommodate different camera heights, seating positions, or orientations of the subject to ensure optimal eye contact.

12. The method of claim 10, wherein the folding prompter device is configured for both scripted and unscripted interviews by utilizing the adjustable side mirror panel for quick switching between viewing the interviewer and reading scripted content.

13. The method of claim 10, wherein the folding prompter device can be quickly folded and transported to different locations, providing a portable and adaptable teleprompter solution for dynamic field environments.

14. A folding prompter system, comprising:
the folding prompter device of any preceding claim;
additional accessories or components that enhance the functionality and adaptability of the folding prompter device for varied interview and presentation formats.

15. The folding prompter system of claim 14, wherein the additional accessories include interchangeable side mirror panels with different reflective properties or shapes to suit specific production needs.
